(19) United States
(12) Patent Application Publication
(10) Pub. No.: US 2016/0350510 A1
(43) Pub. Date: Dec. 1, 2016

(54) METHODS AND SYSTEMS FOR DELIVERING PREVENTATIVE URGENT CARE ON DEMAND USING WEB-BASED RESOURCES INCLUDING PREEMPTIVE TRAVEL KITS PRESCRIBED IN ADVANCE OF LIKELY COMMON EVENTS DURING TRAVEL

(71) Applicant: Phillip E. Schoenwetter, Rancho Palos Verdes, CA (US)

(72) Inventor: Phillip E. Schoenwetter, Rancho Palos Verdes, CA (US)

(21) Appl. No.: 15/165,488

(22) Filed: May 26, 2016

Related U.S. Application Data
(60) Provisional application No. 62/166,599, filed on May 26, 2015.

(51) Int. Cl. G06F 19/00; G06Q 50/14

(52) U.S. Cl. CPC G06F 19/3456; G06Q 50/14; G06F 19/363; G06F 19/328

(57) ABSTRACT

Preventive urgent healthcare services utilizing web-based resources for medical approval and particularly, a preemptive medical kit prescribed in advance of likely common events during travel in North America and the Northern Hemisphere to be treated with a combination of over-the-counter and prescribed medications.

### RELATED APPLICATION DATA

This application claims the benefit of U.S. Provisional Application Ser. No. 62/166,599 filed on May 26, 2015

### BACKGROUND OF THE INVENTION

1. Field of the Invention

The field of the invention is preventative urgent care that utilizes web-based communications and particularly, a preemptive medical kit prescribed in advance of likely common events during travel in North America and the Northern Hemisphere to be treated with a combination of over-the-counter and prescription medications following medical review and medical approval.

2. Description of the Related Art

Conventional healthcare in the U.S. is inefficient. Getting from the patient's need to actual patient care takes too long. The hassles of getting a prescription in the current conventional American system of insurance, minimums, deductibles, authorizations, medical insurance coverage, overcharges by ER and Urgent Care facilities and wasted time spent getting simple remedies for common afflictions that can be self-treated are daunting and waste time for everyone.

It is a major distracter to both business and leisure trips out of town, out of state or to different continents. The situation is analogous to the same reason most people carry a jack and spare tire in their auto hoping that they really won't need them. The public should not have to tolerate the inefficiencies in conventional healthcare. A need exists for an improved system for delivering preventative healthcare that utilizes web-based communications in advance of an anticipated trip.

### SUMMARY OF THE INVENTION

Anticipatory and individualized preemptive prescriptive urgent care kit. Just as anti-malarials are preemptively prescribed prior to trips to known malaria regions to prevent acquisition of malaria, likewise there are a significant number of common afflictions that happen to us all but have much greater impact and consequences when away from home, be it domestic or international travel.

Gastrointestinal infections, upper and lower respiratory tract infections, sleep/circadian (jet lag), allergic and painful conditions can impair the mission of a trip and most of these respond best to a combination of prescription and OTC preparations.

Epipens® and prednisone on occasion are absolutely immediately life saving but require prescriptions. Likewise, so do antibiotics, antivirals, analgesics and effective sleep medications.

The invention herein could be called urgent care in a box, or alternatively, a Swiss army knife for urgent care, or like actually locating a good mini-pharmacy when traveling away from home with a group of friends.

The invention comprises systems and methods for delivering preventative urgent care using web-based resources to aid would-be travelers by delivering the medications they might need while away from home at a particular destination before the traveler leaves for his trip. This is all accomplished with clicks of the mouse without stepping foot in a physical brick and mortar facility.

In embodiments of the invention, an individual with planned upcoming travel first accesses a secure website on the world-wide web only a matter of days before leaving on his trip. The individual inputs responses to a comprehensive online Medication/Patient Questionnaire.

Based on a medical review of the individual's input to the online Questionnaire, the would-be traveler would then receive a notification prior to the individual's travel that indicates whether he has been approved.

With an in-house healthcare staff including doctors and pharmacists, all of the individual's information is quickly processed including a review of the medical profile, medical approval, prescribing the appropriate medications and filling, packing and sending a kit with the medications out to the individual.

The kit will only be sold and delivered to those who have completed the medical approval process. The small but complete kit has an array of over the counter and/or prescription medications that might be needed while on the anticipated trip.

For example, for embodiments of the invention, the medications include but are not limited to a small but complete array of over the counter and prescribed medications that treat the most frequent medical conditions affecting travelers in North America and the Northern Hemisphere.

In further embodiments, the kit includes fourteen different medications that have been personalized to fit the individual's allergy profile. The kit includes a claim form that the individual can send to his insurance provider for reimbursement.

Payment processing is accomplished with several clicks of the mouse by the individual. The individual enters a secure login online, processes the appropriate payment option and inputs a desired shipping address for the kit, reviews his order following medical approval and then clicks submit. This is all accomplished without stepping foot in a physical office space.

An individual may also want to know what kinds of medical situations he might encounter while visiting multiple destinations. In further embodiments, the individual selects the optional feature, the “Custom Medical Guide” request and fills out a brief survey online describing where he is going and what he plans to do at the various destinations. In response, an appropriate destination specific guide is shipped with the kit.

Further advantages and embodiments of the invention will be apparent to persons skilled in the art from the figures and description set forth herein.

### BRIEF DESCRIPTION OF THE DRAWINGS

FIG. 1 illustrates an exemplary embodiment of the invention.

FIG. 2 illustrates another example embodiment of the methods and systems of the invention.

FIG. 3A is an exemplary first page of a Listing Sheet Form with a list of medications in a kit delivered to a would-be traveler following medical approval.

FIG. 3B is an exemplary second page of a Listing Sheet Form with a list of medications in a kit delivered to a would-be traveler following medical approval.

### DETAILED DESCRIPTION OF EMBODIMENTS OF THE INVENTION

Reference is made to the Figures in which features of the illustrated embodiments of the invention are shown and described so as to enable one skilled in the art to make and use the invention. It is understood that the following description is exemplary of embodiments of the invention and it is apparent to skilled persons that modifications are possible without departing from the inventive concepts herein described.

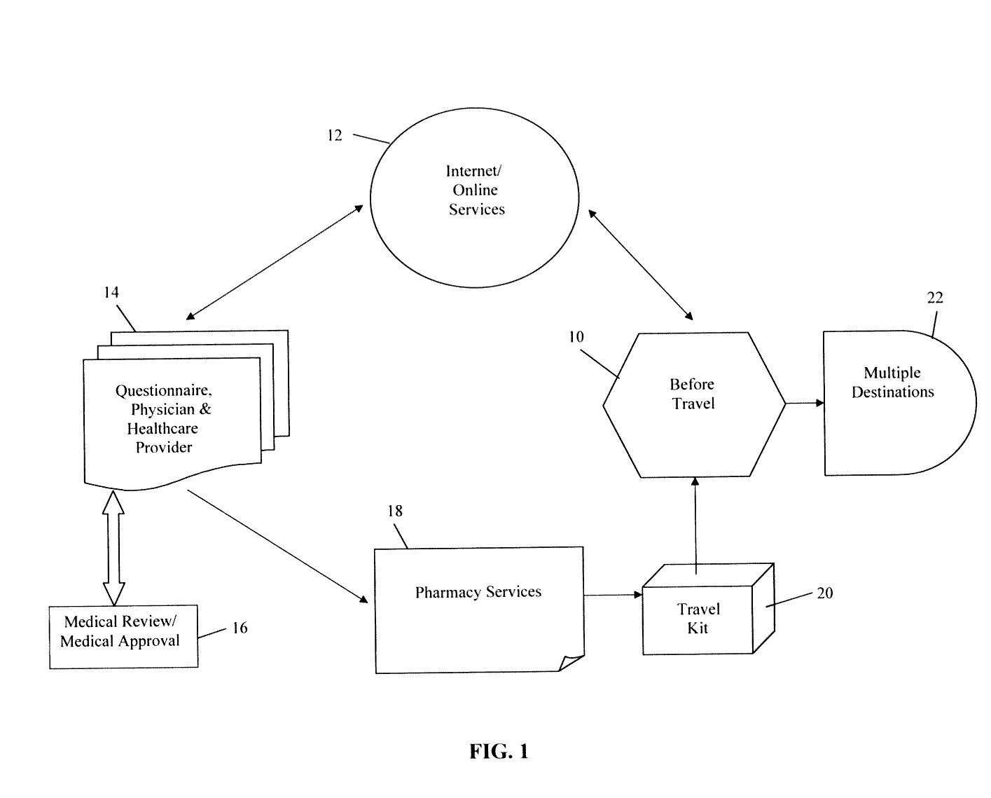

Referring to FIG. 1, in one embodiment an individual or would-be traveler 10 with upcoming travel plans begins the medical approval process by accessing a web-based resource 14 on the internet 12 such as a page on an internet website.

The individual selects the option to begin the Medical Approval Process. The individual then is presented with and is required to respond to a Medication/Patient Questionnaire. The individual first enters name, gender and date of birth. He also enters contact information, an email address, phone number and physical address including city, state and zip code.

In embodiments of the invention, the Questionnaire includes a series of numbered questions asking the individual to respond to each.

First, the individual is presented with the question:

1. Do you have a known allergy or history of any adverse events to any of the below listed medications?

The Questionnaire lists the following medications: Benadryl (or any other Anti-Histamines); Prednisone: Penicillin (or any derivative of Penicillin such as Augmentin/Ampicillin/Amoxicillin); Quinolone Antibiotics (such as Ciprofloxing (Cipro/Levaquin); Sulfa Drugs (including Bactrim DS/Septa DS); Cephalosporin such as Keflex/Suprax); Hydrocodone (or any other Opiate derived drugs, Vicodin/Norco/Codcinc/Oxycodone); Lomotil (Diphenoxylate/Atropine); Benzodiazepine class or type of drugs Xanax/Ambien/Valium/Restoril/Lorazepan); Zantac/Tagamet/Pepcid; Symmetrel/Amantadine or other anti-viral drugs such as Tamiflu or Flumadine; Zofran (Ondansetron); Guaifenesin (cough medicines); Azithromycin (Z-Pak/Erythromycin-Biaxin); Pyridium (Phenazopyridine); and the option: “No known allergies to the medications listed above.”

The Questionnaire includes question nos. 2-6 asking the individual to respond to each question:

2. Do you have any known allergies or adverse reactions to any known medications in the past? (e.g. rashes, itches, breathing issues, etc.)

3. Are you currently taking any regularly prescribed medicines?

4. Are you currently taking any medications that help with sleep/mood/depression/anxiety/etc. issues?

5. List any regularly used non-prescriptive medications (including over the counter, herbal, homeopathic, vitamins, etc.).

6. Are you currently under the care of a physician for any ongoing medical condition?

The Questionnaire includes question no. 7 asking the individual to respond to the question:

7. Have you ever been diagnosed with any of the following medical conditions?

The Questionnaire lists twenty-seven possible conditions including: Anemia; Asthma; Blood clotting Problems; Cancer; Depression; Diabetes; Ear Infections (chronic): Epilepsy Seizures; Eye Problems; G6PD Deficiency; Gout; Hearing Problems; Heart Disease; High Blood Pressure; High Cholesterol; Hormone Problems; Immune System Deficiency; Kidney Disease; Liver Disease/Hepatitis; Lung Disease; Prostate Problems; Psoriasis/Other Skin Problems; Psychiatric Problems; Sickle Cell Disease; Stomach Ulcer; Stroke; Thyroid Problems; and the option “None of the above”

The Questionnaire includes question nos. 8-9 asking the individual to respond to the questions;

8. Are you sensitive to sun exposure?

9. Would you like us to notify your primary care physician?

In embodiments, the provider using the systems and methods disclosed herein has an in-house healthcare staff that includes doctors and pharmacists. The in-house staff performs the review of the medical profile, prescribes and dispenses the appropriate medications, fills and packs the kit 20 and sends the kit 20 out for delivery to an individual's designated address. In further embodiments, the kit 20 is dispensed by appropriate pharmacy services 18. It is expected the medical review and medical approval 16 takes approximately two to three days and the individual receives an email notification with the results.

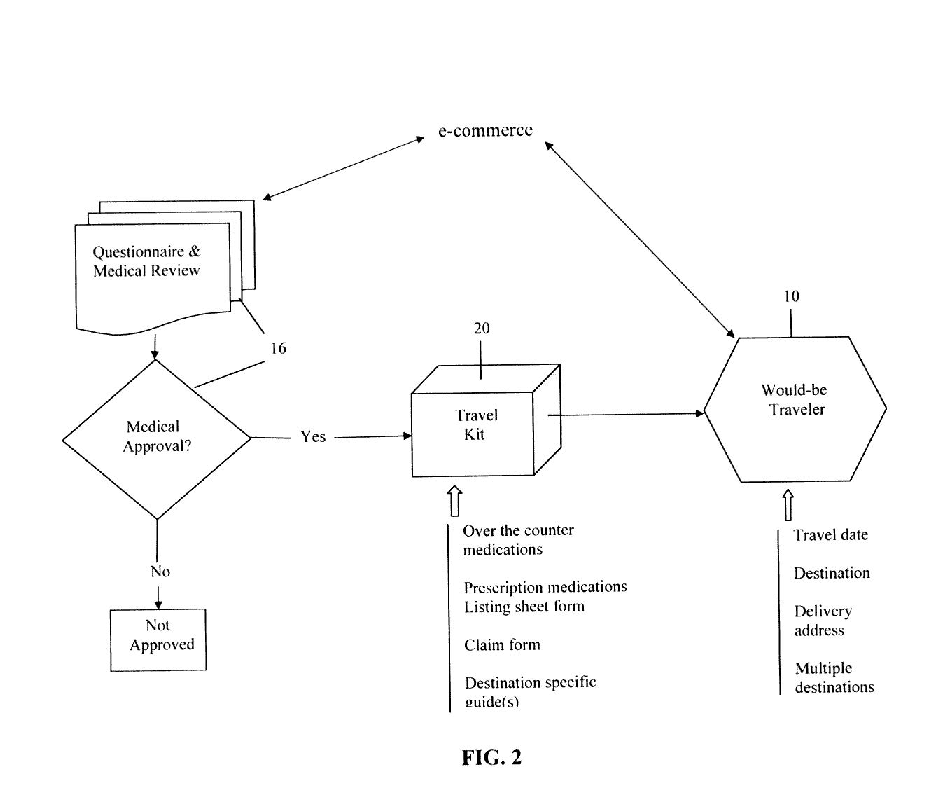

Referring to FIG. 2, the kit 20 will only be sold and delivered to those who have completed the medical approval process 16. The small but complete kit 20 has an array of over the counter and or prescription medications that might be needed by a would-be traveler 10 while on his or her anticipated trip.

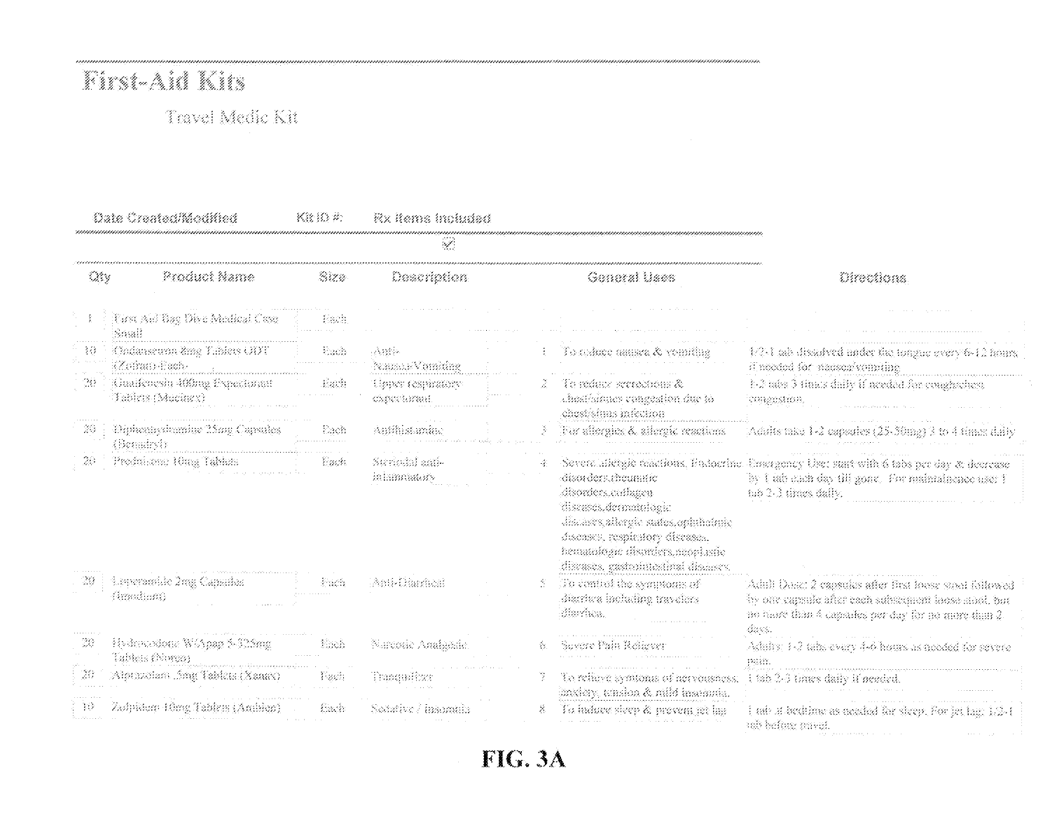

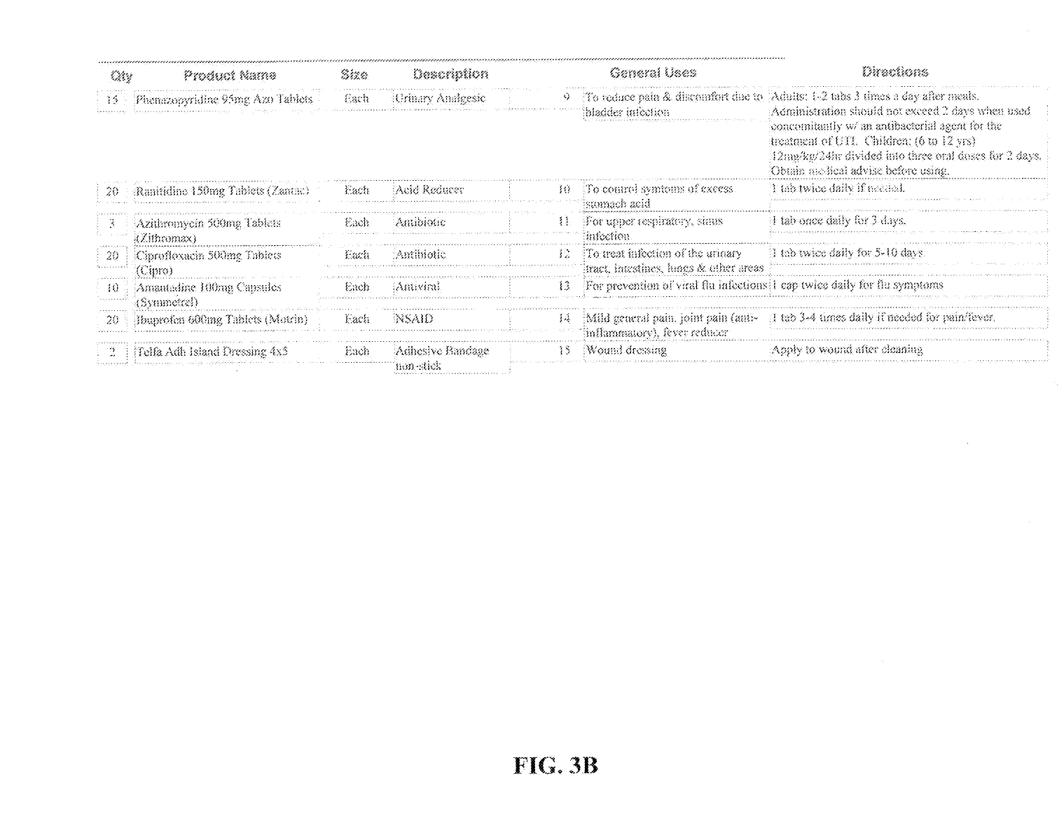

FIG. 3A and FIG. 3B illustrate an exemplary Listing Sheet Form with a tabulated list of the contents of the kit 20 delivered to an individual upon medical approval. In embodiments, the Form shows the kit 20 contains fourteen medications and lists in a detailed descriptive narrative the quantity, the product name, the description and general use and also under “Directions” the prescribed directions for taking the dispensed medications.

In examples, the preemptive medical kit 20 can be tailored to the planned and multiple destinations 22 of the would-be traveler 10. In further embodiments, the kit 20 contains medications prescribed in advance of likely common events during travel in North America and the Northern Hemisphere with a combination of over-the-counter and prescribed medications. Other combinations of medications are within the scope of the invention.

Referring to FIG. 3A and FIG. 3B, one exemplary kit 20 includes: Ondansetron 8 mg Tablets ODT (Zofran); Guaifenesin 400 mg Expectorant tablets (Mucincx); Diphenhydramine 25 mg Capsules (Benadryl); Prednisone 10 mg Tablets; Loperamide 2 mg Capsules (Imodium); Hydrocodone w/Apap 5-325 mg Tablets (Norco); Alprazolam 0.5 mg Tablets (Xanax); Zolpidem 10 mg Tablets (Ambien); Phenazopyridine 95 mg Azo Tablets; Ranitidine 150 mg Tablets (Zantac); Azithromycin 500 mg Tablets (Zithromax); Ciprofloxacin 500 mg Tablets (Cipro); Amantadine 100 mg Capsules(Symmetrel); Ibuprofen 600 mg Tablets (Motrin); and Two Telfa Adh Island Dressing 4×5.

In further embodiments, the would-be traveler 10 selects the optional feature, labeled “Custom Medical Guide” request and fills out a brief survey online. The would-be traveler 10 describes where he is going and what he plans to do at the various destinations. In response, an appropriate destination specific guide is shipped with the kit 20.

While the invention has been described with regards to particular embodiments, it is recognized that additional variations of the invention may be devised by persons skilled in the art without departing from the inventive concepts disclosed and claimed herein.

What is claimed is:

1. A process to provide preventative urgent care using online resources to aid would-be travelers by delivering medications a would-be traveler might need while away from home at a particular destination before the would-be traveler leaves for a trip, comprising:
providing a secure internet website so the would-be traveler with planned upcoming travel accesses the secure internet website before leaving on the planned upcoming travel and inputs responses to an online medication/patient questionnaire;
processing the would-be traveler's input to the online medication patient questionnaire including:
(i) performing an appropriate medical review of the would-be traveler's input and medical profile,
(ii) giving appropriate medical approval,
(iii) prescribing the appropriate medications,
(iv) transmitting medical approval to the would-be traveler prior to the individual's planned upcoming travel that indicates whether the individual has been approved, and
(v) upon the medical approval, filling, packing and sending a kit with the medications lo the would-be traveler and the kit has an army of over the counter and/or prescription medications for use during the planned upcoming travel wherein the kit will only be sold and delivered to a would-be traveler who has completed the medical approval process.

2. The process of claim 1 wherein the kit includes an array of over the counter medications and prescription medications that might be needed during the planned upcoming travel.

3. The process of claim 2 wherein the medications include over the counter medications and prescribed medications that treat the most frequent medical conditions affecting travelers in North America and the Northern Hemisphere.

4. The process of claim 1 wherein the kit includes at least fourteen different medications that have been personalized to fit the would-be traveler's allergy profile.

5. The process of claim 4 further comprising a form, the form showing the kit includes at least fourteen medications and listing the quantity, the product name, the description, general use and directions for taking the dispensed medications.

6. The process of claim 4 further comprising a claim form that the would-be traveler can send to an insurance provider for reimbursement.

7. The process of claim 1 including the step of payment processing wherein the would-be traveler enters a secure login online, processes the appropriate payment option, inputs a desired shipping address for the kit and reviews the order following medical approval.

8. The process of claim 1 including the steps of:
the would-be traveler selects an optional feature to inquire into what kinds of medical situations the would-be traveler might encounter while visiting multiple destinations, and
the would-be traveler fills out a survey online describing where he is going and what he plans to do at the various destinations.

9. The process of claim R including the steps of:
shipping an appropriate destination specific guide to the would-be traveler in response to input to the survey by the would-be traveler.

10. An e-commerce system to provide a preemptive medical kit prescribed in advance of likely events during upcoming anticipated travel using online resources by delivering medications a would-be traveler might need while away from home at a particular destination before the would-be traveler leaves for a trip, comprising:
a secure internet website so the would-be traveler with planned upcoming travel accesses a secure internet website before leaving on a trip wherein the would-be traveler inputs responses to an online medication/patient questionnaire;
processing the would-be traveler's input to the online medication/patient questionnaire with a healthcare staff, including:
(i) performing an appropriate medical review of the would-be traveler's input and medical profile,
(ii) giving appropriate medical approval,
(iii) prescribing the appropriate medications,
(iv) transmitting medical approval to the would-be traveler prior to the would-be traveler's planned upcoming travel that indicates whether the would-be traveler has been approved, and
(v) upon the medical approval, filling, packing and sending a kit with the medications to the would-be traveler and the kit includes over the counter and/or prescription medications for the planned upcoming travel wherein the kit will only be sold and delivered to a would-be traveler who has completed the medical approval process.

11. The system of claim 10 where the kit includes an array of over the counter medications and prescription medications.

12. The system of claim 10 where the medications include over the counter medications and prescribed medications that treat the most frequent medical conditions affecting travelers in North America and the Northern Hemisphere.

13. The system of claim 10 where the kit includes at least fourteen different medications that have been personalized to fit the would-be traveler's allergy profile.

14. The system of claim 13 further comprising a form, the form showing the kit includes fourteen medications and listing the quantity, the product name, the description, general use and directions for taking the dispensed medications.

15. The system of claim 13 further comprising a claim form that the would-be traveler can send to an insurance provider for reimbursement.

16. The system of claim 10 where the would-be traveler enters a secure login online, processes the appropriate payment option, submits payment, inputs a desired shipping address for the kit and is allowed to review the order following medical approval.

17. The system of claim 10 further comprising:
the would-be traveler selects an optional feature to inquire into what kinds of medical situations the would-be traveler might encounter while visiting multiple destinations, and
the would-be traveler fills out a survey online describing where he is going and what he plans to do at the various destinations.

18. The system of claim 17 including the steps of:
shipping an appropriate destination specific guide to the would-be traveler in response to input to the survey by the would-be traveler.
